(19) United States
(12) Patent Application Publication
(10) Pub. No.: US 2012/0006249 A1
(43) Pub. Date: Jan. 12, 2012

(54) Portable Boat

(76) Inventor: Gary Harder, Lake Mary, FL (US)

(21) Appl. No.: 12/831,465

(22) Filed: Jul. 7, 2010

(51) Int. Cl. B63B 7/04; B23P 11/00

(52) U.S. Cl. 114/352; 29/428

(57) ABSTRACT

A portable boat and related method of manufacture. In one embodiment the boat includes first and second hulls and a deck member, each configured to be securely interlocked to another to assemble the boat. The deck member includes: at least one tenon extending outward from the starboard side for connection with the first hull and at least one tenon extending outward from the port side for connection with the second hull. Each of the hulls includes at least one slotted opening for receiving one of the tenons to connect the hull to the deck member, so that when at least one tenon is inserted into one of the hulls, the hull is securely fastened to the deck member with the aid of a fastener extending from the hull into the deck tenon.

### FIELD OF THE INVENTION

This invention relates to watercraft and, more particularly, to boats of the type having catamaran hulls and methods of making such craft.

### BACKGROUND OF THE INVENTION

Traditionally, watercraft have been of a monohull design, but small single hull craft have suffered from several disadvantages, notably a pronounced instability when a person attempts to stand up in the craft. Recognizing the greater stability offered by dual hull vessels, at times referred to as catamaran hulls, a growing number of designs are becoming available for small and medium craft (e.g., up to 20 feet in length). Ideally, many users of these boats desire that they be large enough to provide comfort and conveniences to make a day outing more effective and enjoyable. Whether the outings involve fishing, diving, hunting or other activities, there should be ample room to carry gear, food and supplies. However, boats that meet these simple criteria are relatively heavy and inconvenient to transport and launch. Even smaller boats which do not require trailers often require the efforts of two people to mount the boat on the roof of a vehicle or to safely remove the boat near a launch site. As a compromise many smaller craft, for which deployment can be effected by one person, are available, but these generally do not provide the ability to walk around and are often too unstable for a person to safely stand up in the boat. Generally, there has been a need for watercraft that offer greater space and stability while also meeting the need for portability such that one person should be able to transport and launch the boat.

Many people who fish would rather fish from a boat than from piers, docks, bridges, or shores. In addition to the costs of owning and maintaining a boat, other impediments include the inconveniences of finding or paying for safe storage, and transporting and launching the boat. Generally, most fishing kayaks do not provide enough room for the large amount of gear an avid angler typically wishes to carry. Further, with such restricted room, it is uncomfortable to remain seated in one position for the many hours a serious angler spends fishing.

### BRIEF SUMMARY

According to the invention a boat is provided which has enhanced portability while providing many of the functions or conveniences normally limited to heavier vessels which require a trailer for transporting or which require multiple persons to carry. Boats according to several embodiments of the invention can be readily and repeatedly assembled or disassembled to make transportation of such boats fast, simple and convenient.

According to one series of embodiments, a method is provided for manufacturing a portable boat which, when assembled, includes first and second hulls spaced apart a predetermined distance, with the first hull connected to a starboard side of a deck member and the second hull connected to a port side of the deck member. The deck member extends from a fore member to an aft member. The method includes forming a series of interlockable components including the first and second hulls and the deck member which are each configured to be securely interlocked to another in order to assemble the boat, which components, when assembled, result in connection of each hull along a different side of the deck member. Forming the deck member includes forming at least one deck tenon extending outward from the starboard side of the deck member for connection with the first hull and at least one deck tenon extending outward from the port side of the deck member for connection with the second hull, and forming the deck member so that the assembled boat has a continuous surface area on the deck member and between the first and second hulls over which a passenger can walk and be seated. Forming each of the hulls includes forming at least one slotted opening for receiving one of the tenons to connect the hull to the deck member, so that when at least one deck tenon is inserted into one of the hulls, the hull is securely fastened to the deck member with the aid of a fastener extending from the hull into the deck tenon.

According to a series of embodiments, boats according to the invention include first and second hulls spaced apart a predetermined distance, with the first hull connected to a starboard side of a deck member and the second hull connected to a port side of the deck member, wherein the deck extends from a fore member to an aft member. An exemplary boat comprises multiple interlockable components including the first and second hulls and the deck member, each configured to be securely interlocked to another to assemble the boat, which components, when assembled, result in connection of each hull along a different side of the deck member. The deck member includes at least one deck tenon extending outward from the starboard side of the deck member for connection with the first hull and at least one deck tenon extending outward from the port side of the deck member for connection with the second hull, and the assembled boat has a continuous surface area on the deck member between the first and second hulls over which a passenger can walk and be seated. Each of the hulls includes at least one slotted opening for receiving one of the tenons to connect the hull to the deck member, so that when at least one deck tenon is inserted into one of the hulls, the hull is securely fastened to the deck member with the aid of a fastener extending from the hull into the deck tenon.

### BRIEF DESCRIPTION OF THE DRAWINGS

The invention will be further understood and appreciated from the following detailed description when read in conjunction with the drawings in which:

FIG. 1 is a perspective view of a boat according to a first embodiment of the invention;

FIG. 2 illustrates a deck member of the boat shown in FIG. 1;

FIG. 3 is an exploded view of the boat shown in FIG. 1;

FIG. 4A is a detailed view of interlocking members of the boat shown in FIG. 1 wherein a fishing rod holder is incorporated as a fastener;

FIG. 4B is a side view in cross section, taken along the centerlines of hull sections, further illustrating interlocking members of the boat;

FIG. 4C is a magnified side view in cross section relative to FIG. 4B, taken along the centerline of one hull section, further illustrating interlocking members of the boat;

FIG. 4D is a perspective view of the fishing rod holder shown in FIGS. 4A and 4B positioned within a hull section to interlock members of the boat shown in FIG. 1;

FIG. 5 is a perspective view of a boat according to a second embodiment of the invention; and

FIG. 6 is an exploded view of the boat shown in FIG. 5.

### DETAILED DESCRIPTION OF THE INVENTION

Before describing example embodiments of the invention, it is noted that the invention includes a novel and non-obvious combination of elements and method steps. So as not to obscure the description, details of elements and steps pertinent to the invention are emphasized in the figures and written description, without illustrating in the figures certain associated elements and steps which are otherwise conventional or which will be readily apparent to those skilled in the art.

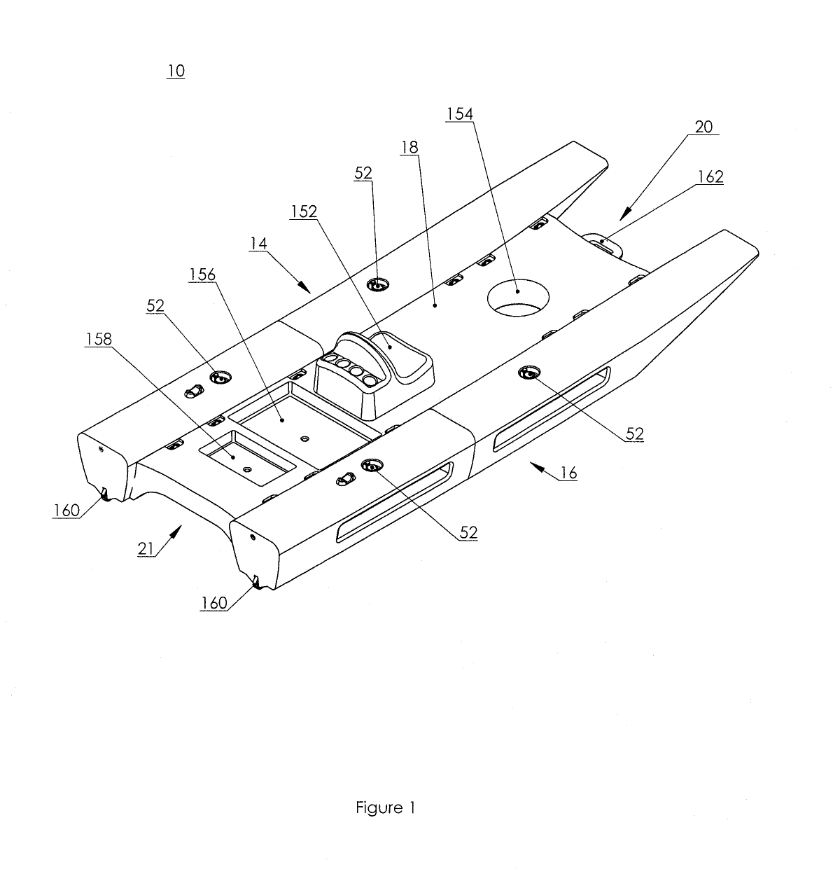

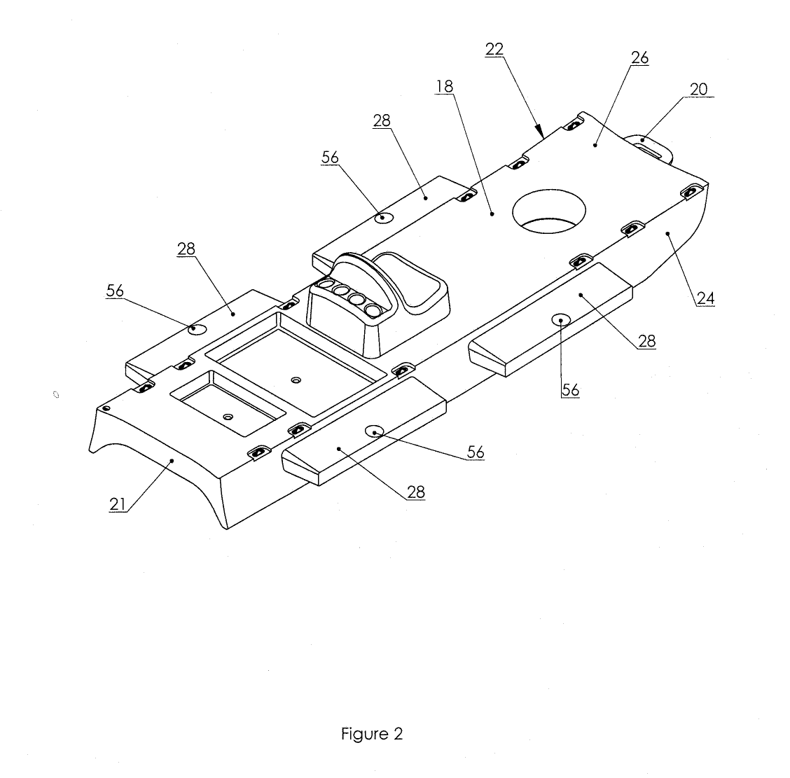

With reference to the simplified perspective view of FIG. 1 there is shown, according to one embodiment of the invention, an exemplary boat 10 in an assembled configuration comprising three major components, a first hull 14, a second hull 16 and a deck member 18, which collectively form what is commonly referred to as a catamaran watercraft. The boat 10 includes a fore portion 20 which is forward-most relative to forward motion of the boat, and an aft portion 21 which is rear-most relative to forward motion of the boat. The deck member 18, also shown in FIG. 2, is a platform-like structure which, when the boat is afloat, provides multiple utilitarian functions, including a standing and walking surface, seating, and surface area for secure placement of containers.

As used herein to describe features of the boat 10, the term length refers to a distance measurable along a direction parallel with the major dimension of the boat and its hulls. Measured lengths are substantially aligned with the primary direction of intended ship motion or thrust, i.e., a direction parallel with a centerline extending from the fore portion to the aft portion, such as, for example, the length of a hull or the length of the deck member which are each measured from fore to aft. The term width refers to a distance measurable along a direction normal to the length. Reference to a width corresponds generally to distance along the same direction as the direction of measure from one hull, e.g., hull 14 to another hull, e.g., hull 16, including smaller distances measured along the same direction, such as measurements corresponding to the width of an individual hull as well as any intermediate distance between the hulls. The lengths and widths of boats according to the invention may vary considerably but are generally on the order of six feet (or about 2 meters) or more in length with overall widths of about 42 inches (or about 105 centimeters), with the deck member having a width of about 26 inches (66 centimeters) or more as measured along the upper surface and between the hulls. Smaller sized craft based on the principles disclosed herein will find use in a wide variety of applications including provision of light-weight and portable emergency craft and life boats which can be compactly stowed on another vessel.

For purposes of comparison it is noted that most prior art catamaran craft of similar style, e.g., having a walkable deck surface extending between hull members, also have dimensions of at least those noted above for the boat 10. However, due to the size and weight these craft often must be towed with a trailer are bulky and are difficult for a single person to launch or remove from the water. Watercraft of smaller dimensions, some of which are referred to as kayaks, can be of lesser weight and smaller widths. See, for example, U.S. Pat. Nos. 5,189,974, 5,649498, 6,112,692 and 6,871,608. So-called fishing kayaks are a class of small watercraft which have limited space for seating and gear. These craft are popular in part because more limited size and weight facilitates ease of transport. The water enthusiast often has to accept disadvantages to attain portability. Ideally, those who indulge in sport fishing and other water activities (e.g., duck hunting and diving) would like a boat having the advantages of a larger, heavier catamaran style watercraft or monohull vessel which can provide a deck area suitable for standing up, walking and storage of containers such as bait buckets, coolers and gear boxes.

According to the invention, the boat 10 provides advantages over other boats in a similar design class, and of similar size and weight, while also providing portability and economy. Designs according to the invention enable a wider class of enthusiasts to experience the benefits of larger craft without having to incur the inconveniences of transporting a larger, relatively heavy vessel.

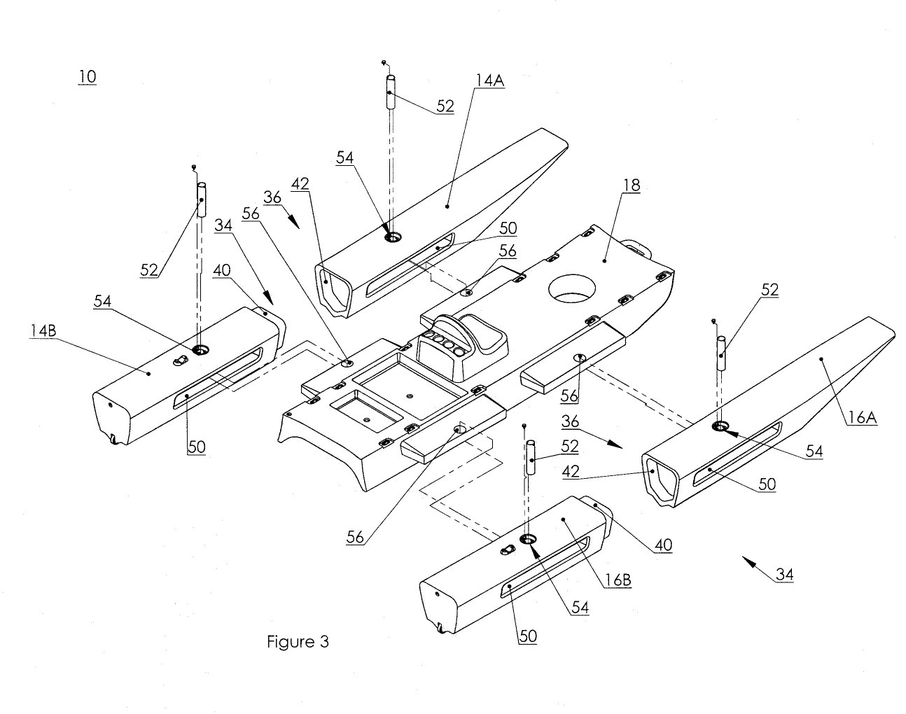

As illustrated in FIGS. 2 and 3, the boat 10 is formed of a series of interlockable components including the first and second hulls 14 and 16 and the deck member 18. In this example the hulls 14 and 16 are each formed of separate, connectable sections 14A, 14B and 16A, 16B, respectively. As used herein the term interlockable refers to a connection which can be made among two, three or more components which connection is securable in the sense that the components are held in place when subjected to forces which might otherwise separate the components. According to embodiments of the invention two or more components are interlocked, each to another, by provision of a fastener component.

As now described, the components 14A, 14B, 16A, 16B and 18 can each be connected and securely locked in place without use of tools in order to assemble the boat 10. Advantageously, the components can also be easily separated from one another. Thus the boat 10 is readily made available in a disassembled form so that individual components can be easily fit in a vehicle for transport. Further, because the individual components are relatively small and light, one person can assemble or disassemble the boat and carry the components individually when loading and unloading the boat.

The section 14A is a fore member of the hull 14 and the section 14B is an aft section of the hull. Similarly, the section 16A is a fore member of the hull 16 and the section 16B is an aft section of the hull 16. A hull tenon 40 for insertion into the hull section 14A is formed at the fore end 34 of the hull section 14B. A recess 42 for receiving the hull tenon 40 of the hull section 14B is formed at the aft end 36 of the hull section 14A. The tenon 40 and the recess 42 of the hull 14 are sized such that with insertion of the tenon 40 into the recess 42 a sliding engagement results in a snug fit of one into the other. Similarly, a hull tenon 40 for insertion into the hull section 16A is formed at the fore end 34 of the hull section 16B. A recess 42 for receiving the hull tenon 40 of the hull section 16B is formed at the aft end 36 of the hull section 16A. The tenon 40 and the recess 42 of the hull 16 are sized such that with insertion of the tenon 40 into the recess 42 a sliding engagement results in a snug fit of one into the other. The engagement of the hull components can, of course, be effected by reversing the arrangement of the hull tenon 40 and the recess 42 such that the hull tenon is formed at the aft end of the fore member section of a hull and the recess is formed on the fore end of the aft section of the hull. The hull components and the deck member 18 may all be formed of plastic in a rotational molding (rotomolding) process or a blow molding process.

The deck member 18 includes a pair of symmetrical port and starboard sides 22 and 24 and an upper surface 26 along which numerous and varied utilitarian features may be formed during the molding process. Also as part of the molding process by which the deck member 18 is fabricated, two deck tenons 28 are positioned along each side 22 and 24. The deck tenons are each oriented to extend outward and away from one of the deck member sides 22 or 24. The deck tenons 28 may be formed as part of the deck member 18 during the molding process or may be inserts which are designed to fit into recesses which would then be formed within the deck member 18 in a mortice and tenon style and then may be locked in place with a fastener. A similar arrangement is described herein with respect to insertion of the deck tenons 28 into recesses formed in the hulls 14 and 16. As shown in the figures, the deck member 18 has a continuous surface 26 between the first and second hulls over which a passenger can both walk and be seated. In addition, the surface is of sufficient area to accommodate placement of containers such as gear boxes, bait buckets and gear relating to numerous and varied water activities. The deck member of the boat 10 has a width of about 30 inches (76 cm) and a length of about 9 feet (3 meters).

Each of the hull sections 14A, 16A, 14B and 16B includes at least one slotted opening 50, which may extend through the hull section, for receiving one of the deck tenons 28 in order to connect the hulls to the deck. With the tenons 28 on a side 22 or 24 of the boat inserted into both of the hull sections in a pair 14A, 14B or 16A, 16B, and with the aid of fasteners 52 each extending from one of the hull sections into the tenon, the hull sections become securely fastened to the deck member 18 and to one another. The combination of the pairs of hull sections 14A, 14B and 16A, 16B and the deck member 18 are thus assembled as a rigid structure suitable for movement of the boat 10 over water.

In the illustrated designs the deck tenons 28 are wedge-shaped, having lengths of about 30 inches (76 centimeters), widths of about 10 inches (25 centimeters) and tapered thicknesses increases decreasing from about 4 inches (10 centimeters) along the side 22 or 24 of the deck member from which they extend to about 2.5 inches (6 cm) at the ends farthest away from the deck member side. The deck tenons may be rectangular or fluted. Still other shapes are suitable.

A feature of the embodiment shown in FIGS. 1, 2 and 3 is that for a boat design having hulls of a specified length, each of the sections 14A, 14B or 16A, 16B have a length smaller than the specified length, which lengths are combined when the sections are connected to provide the specified length. For example, with a hull having a specified length of about 11 feet (3.3 meters), the fore hull section will have a length of about six feet (2 meters) and the aft hull section will have a length (excluding the length of the hull tenon 40) of about 5 feet (1.5 meters). With this arrangement hull components are provided which are smaller and lighter than full size hulls, this making the stowing and carrying of the hulls easier and more convenient.

The concept of using hull sections to form the full length of a hull can be extended to further reduce the size of the hull segment components. For example, for the boat 10 having hull lengths of about 11 feet (3.3 meters), the hulls may be formed of three sections so that no individual hull section is longer than 4 feet.

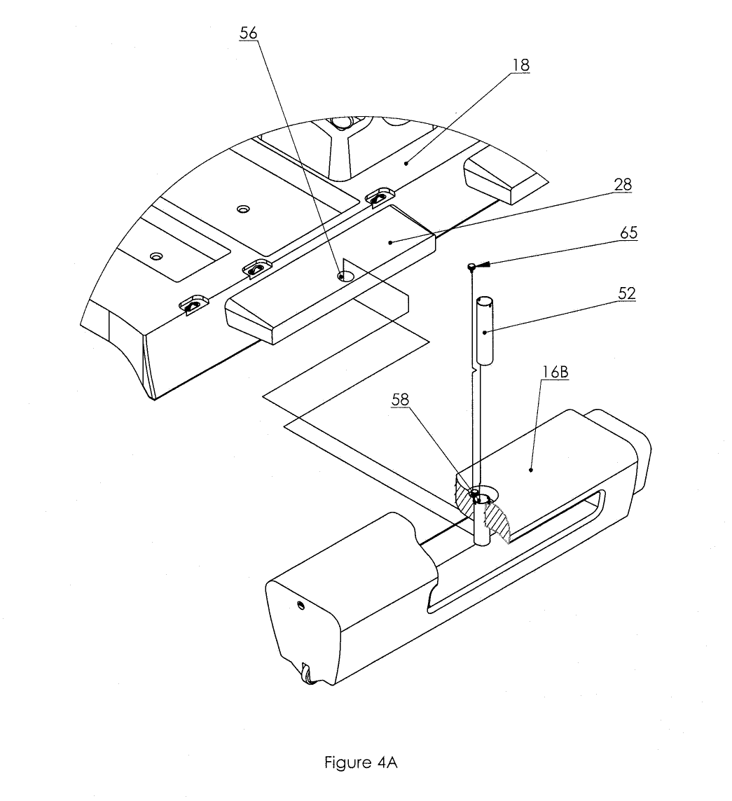

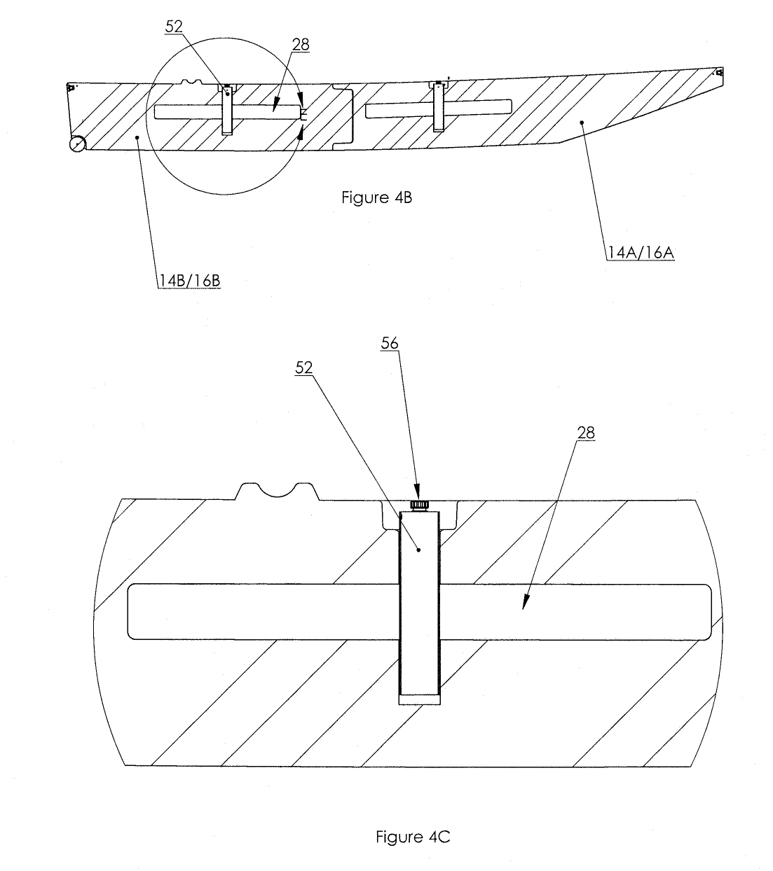

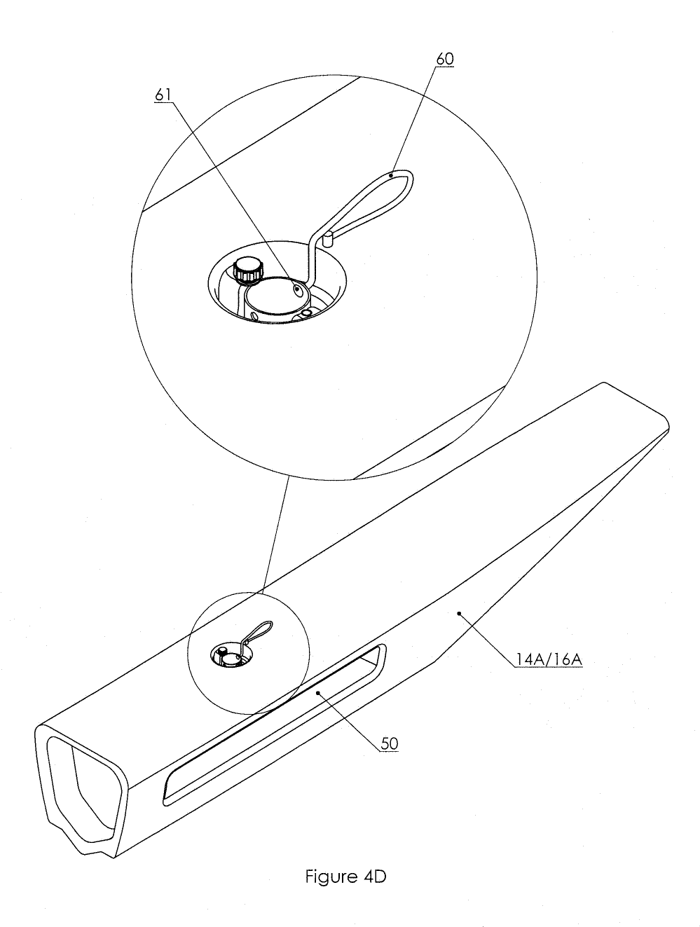

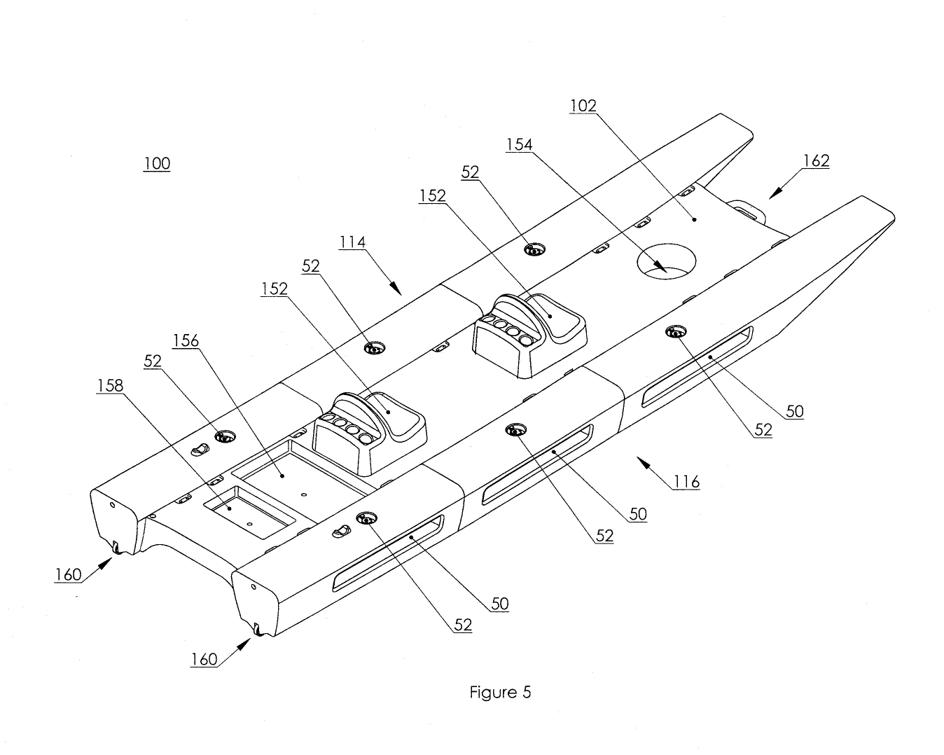

Another feature of the invention is the design and method of applying the fasteners 52 to secure the components. With reference also to FIGS. 4A-4C, the hull components 14A, 14B or 16A, 16B each include an aperture 54 formed therethrough and which can be aligned with an aperture 56 formed through a mating deck tenon 28 when the tenon is positioned in the slotted opening 50 associated with the hull component. A fastener 52 is then passed through both of the openings 54 and 56 to lock the connected hull and deck tenon components in place relative to one another. With the sliding engagement of one hull section into another hull section, the pairs of fore and aft sections which form each hull become locked in place when the fasteners 52 lock the deck tenons 28 in place within the hull sections.

Still another feature of the invention is that design of the fasteners 52 provides a dual functionality. As further shown in FIG. 4, the fasteners 52 can function as rod holders, being formed of metal tubing, sized appropriately to act as dowel pins extending through a hull section and a deck tenon. As shown in the partial cut-away view of FIG. 4A, the rod holder fastener 52 can be secured in place with a thumbscrew clamp arrangement where a thumbscrew 65 captures an edge of the rod holder fastener. The thumbscrew is turned into a threaded insert 58 which is placed along an edge of the opening 54. See, also, the views in cross section of FIG. 4B and FIG. 4C. As shown in the perspective view of FIG. 4D, a tether 60 can be attached to an upper portion of the rod holder fastener 52, e.g., through a through hole 61 formed therein, to provide an ability to attach items to the rod holder, such as a bait bucket which could float in water next to the hull.

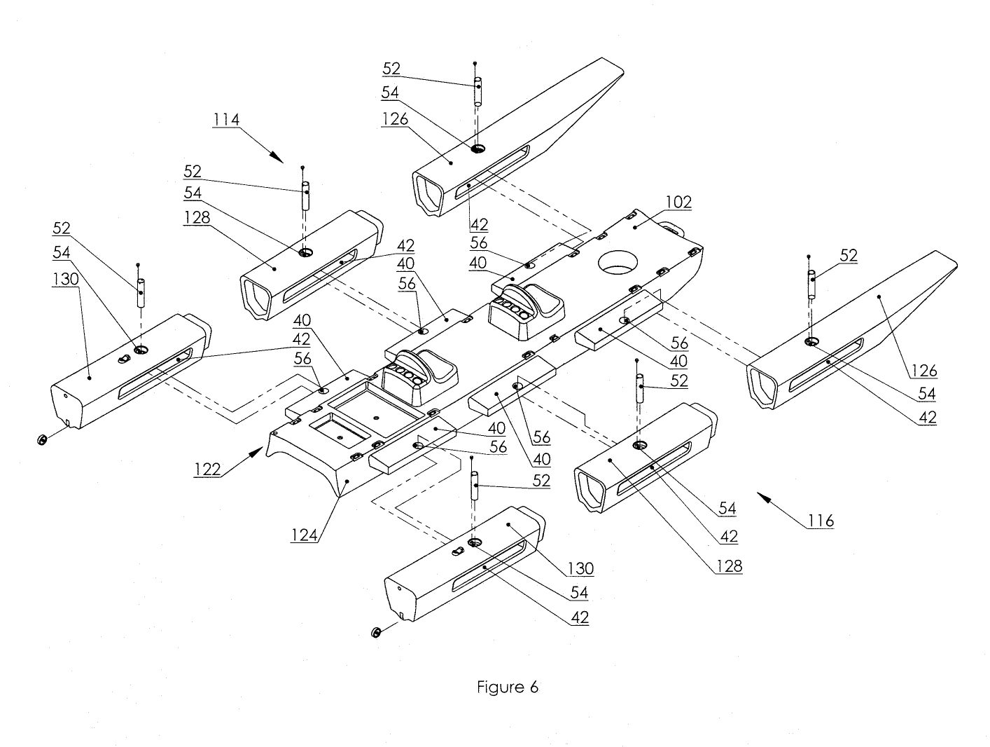

The concept of using hull sections to form the full length of a hull can be extended to further increase the size of a boat. The perspective view of FIG. 5 illustrates a boat 100, according to an alternate embodiment of the invention, having a deck member 102 and hulls 114 and 116 mounted on each side 122, 124 of the deck member. The deck member is approximately 18 feet (6 meters) in length, and the hull lengths are about 21 feet (7 meters). Each of the hulls 114 and 116 is formed of three sections in a manner similar to that described for the boat 10. With reference also to the exploded view of FIG. 6, each hull comprises a fore section 126, a mid section 128 and an aft section 130 which are connected to one another in a manner similar to that described for the hulls of the boat 10.

A hull tenon 40 for insertion into a hull mid section 128 is formed at the fore end 134 of each hull aft section 130. A recess 42 for receiving a hull tenon 40 of a hull aft section 130 is formed at the aft end 136 of each mid hull section 128. Similarly, a hull tenon 40 for insertion into a hull fore section 126 is formed at the fore end 138 of each hull mid section 128 and a recess 42 for receiving a hull tenon 40 of the hull mid section 130 is formed at the aft end 140 of the hull fore section 126. Each pair of mating tenon and recess is sized such that with insertion of the tenon 40 into the recess 42, a sliding engagement results in a snug fit of one into the other. As discussed for the boat 10, engagement of the hull components of the boat 100 with one another can, of course, be effected by reversing the arrangement of a hull tenon 40 and a recess 42 on respective components 126, 128 and 130. All of the hull components and the deck member 102 may be formed of plastic in a rotational molding process or a blow molding process.

With further reference to FIG. 6, the deck member 102 includes an upper surface 162 which extends between the pair of symmetrical port and starboard sides 122 and 124. Numerous utilitarian features may be formed along the surface 162 during or after the molding process. Also as part of the molding process by which the deck member 102 is fabricated, three deck tenons 28 are positioned along each side 122 and 124. The deck tenons 28 are each oriented to extend outward and away from one of the deck member sides 122 or 124. The deck tenons 28 may be formed as part of the deck member 102 during the molding process or may be inserts which are designed to fit into recesses which would then be formed within the deck member 102 in a mortice and tenon style and which then may be locked in place with a fastener as per the similar arrangement described with respect to insertion of the deck tenons 28 into recesses formed in the hulls 14 and 16 of the boat 10. As shown in the figures, the deck member 102 has a continuous surface 162 between the hulls 114 and 116 over which a passenger can both walk and be seated. In addition, the surface is of sufficient area to accommodate placement of containers such as gear boxes, buckets and gear relating to numerous and varied water activities. The deck member 102 of the boat 100 has a width which may range from less than about 30 inches (76 cm) to more than about 48 inches (1.2 meters). Each of the hull sections 126, 128 and 130 includes at least one slotted opening 50 for receiving one of the deck tenons 28 in order to connect the hulls to the deck. The slotted openings extend all the way through the hulls, enabling the hull sections 126, 128 and 130 to be interchangeable between the port and starboard sides of the boat 100. In other embodiments the deck member 102 may include multiple deck tenons 28 for insertion into each of the hull sections. With the deck tenons 28 on each side 122 or 124 of the boat 100 inserted into three of the hull sections 126, 128 and 130, and with the aid of fasteners 52 (e.g., rod holders per FIG. 4) each extending into a hole 54 in one of the hull sections and further into a hole 56 of a deck tenon 28, the hull sections become securely fastened to the deck member 100 and to one another. The holes 54 in the hull sections may extend completely through the hull sections so that the fasteners extend all the way through the holes 54 and further into or fully through the hull sections. A similar arrangement may be configured for the hull sections and deck tenons of the boat 10. More generally, the combination of two sets of multiple hull sections (e.g., sections 126, 128 and 130) and the deck member 102 are thus assembled as one rigid structure suitable for movement of the boat 100 over water.

Boats according to the invention may accommodate numerous amenities some of which are shown in the embodiments of FIG. 1 and FIG. 5, including one or more seats 152; a hole 154 extending through the deck member 18/102 for placement therein of a bait bucket 154; numerous recesses 156/158 along the deck surface for placement of gear containers, a cooler, a tackle box and/or a trolling motor battery; wheels 160 for carting the assembled boat to and from the water; and a handle 162 for pulling and steering the boat when moving it on the wheels.

The wheels 160 can be mounted in molded axle yokes. With a simple wheel assembly the boat can be easily moved to and away from the launch site, and one person can cart it to the water. Recesses formed in the bow can also serve as hand hole handles. Two handles 162 can be provided for two persons to cart the boat if desired. An advantage of the invention is that the user does not have to separately load gear into the boat. Rather, the boat has enough surface area that containers of gear can be loaded into the boat.

The hole 154 may accommodate a standard five gallon bucket to serve as a bait well. Holes formed about the bottom of such a bucket will expose the contents to the water, thereby providing for automatic water replenishment, creating inexpensive live bait well. Boats according to the invention can be adapted for numerous uses including emergency activities and may serve as a stable and convenient diving platform. In other embodiments boats according to the invention may incorporate sails and rudders and may be powered by various types of motors. Components of the boat may be filled with foam or other material to facilitate buoyancy. Other features such as a removable duck blind can be added when using the craft for hunting. Additional recesses can be formed in the deck member to store upright fishing poles and nets, and additional eyelets can be included for tethering other items.

A boat has been described which is relatively light in weight, portable and more convenient to use than, for example, a conventional fishing kayak. With pontoons located on each side, the boat deck is stable enough to stand and walk on. Because the pontoons can be disconnected from and re-connected to the deck member of the boat, the boat can be transported in a disassembled form in an average SUV, pick-up truck or station wagon. Designs of the boat are more compact and convenient for transport when each hull is formed in two or more sections that can be disconnected from and re-connected to both one another and the deck member. When deploying an embodiment of the boat according to FIG. 1, there is normally no need for a second person to assist in assembling or launching the boat. Each hull section is light enough for one person to carry to the launch site. There it can be quickly assembled by fitting the pieces together and by inserting the exemplary rod holder fasteners.

The illustrations provided are exemplary and the invention is not so limited. Rather, the scope of the invention is only limited by the claims which now follow:

The claimed invention is:

1. A method for manufacturing a portable boat of the type which, when assembled, includes first and second hulls spaced apart a predetermined distance, with the first hull connected to a starboard side of a deck member and the second hull connected to a port side of the deck member, wherein the deck member extends from a fore portion to an aft portion, comprising:
forming a series of interlockable components including the first and second hulls and the deck member which are each configured to be securely interlocked to another in order to assemble the boat, which components, when assembled, result in connection of each hull along a different side of the deck member,
wherein forming the deck member includes:
(i) forming at least one deck tenon extending outward from the starboard side of the deck member for connection with the first hull and at least one deck tenon extending outward from the port side of the deck member for connection with the second hull, and
(ii) forming the deck member so that the assembled boat has a continuous surface area on the deck member and between the first and second hulls over which a passenger can walk or be seated, and
wherein forming each of the hulls includes forming at least one slotted opening for receiving one of the tenons to connect the hull to the deck member, so that when at least one deck tenon is inserted into one of the hulls, the hull is securely fastened to the deck member with the aid of a fastener extending from the hull into the deck tenon.

2. The method of claim 1 wherein each of the first and second hulls is formed to provide a predetermined hull length when the boat is assembled, by providing multiple separate but connectable hull sections each having a length smaller than the predetermined length which lengths, when the sections are connected, add to provide the predetermined length.

3. The method of claim 2 wherein forming the deck member includes:
forming at least two deck tenons extending outward from the starboard side of the deck member for connection with the first hull and at least two deck tenons extending outward from the port side of the deck member for connection with the second hull, and
forming each of the first and second hulls with two separate but connectable hull sections each including at least one slotted opening for receiving one of the deck tenons to connect each of the hulls to the deck.

4. The method of claim 2 wherein for each hull, by connecting the sections of the hull and receiving one of the deck tenons into a slotted opening in each of the connectable sections the sections of the hull are secured to one another and the hull is secured to the deck member.

5. The method of claim 4 wherein the sections of the each hull are secured to one another and the hull is secured to the deck member with fasteners that extend through the hull sections and deck tenons.

6. The method of claim 2 wherein forming the deck member includes:
forming at least three deck tenons extending outward from the starboard side of the deck member for connection with the first hull and at least three deck tenons extending outward from the port side of the deck member for connection with the second hull, and
forming each of the first and second hulls with at least three separate but connectable hull sections each including at least one slotted opening for receiving one of the deck tenons to secure the connectable hull sections of each hull together and connect each of the hulls to the deck.

7. The method of claim 3 wherein the step of forming a first of the connectable hull sections includes forming a hull tenon for insertion into a second one of the connectable hull sections and the step of forming the second of the connectable hull sections includes forming a recess therein for receiving the hull tenon.

8. The method of claim 6 wherein the step of forming a first of the connectable hull sections includes forming a hull tenon for insertion into a second one of the connectable hull sections and the step of forming the second of the connectable hull sections includes forming a recess therein for receiving the hull tenon.

9. The method of claim 3 wherein the first hull section of the first hull is interchangeable with the first hull section of the second hull.

10. The method of claim 3 wherein the one hull section of the first hull is interchangeable with one hull section of the second hull.

11. The method of claim 6 wherein one hull section of the first hull is interchangeable with one hull section of the second hull.

12. The method of claim 3 wherein the slotted opening formed in each hull extends through the hull from one side of the hull to the other side of the hull so that each hull can be interchangeably connected to the tenon extending outward from the starboard side of the deck member or to the tenon extending outward from the port side of the deck member.

13. The method of claim 6 wherein the slotted opening formed in each hull extends through the hull from one side of the hull to the other side of the hull so that each hull can be interchangeably connected to the tenon extending outward from the starboard side of the deck member or to the tenon extending outward from the port side of the deck member.

14. The method of claim 1 wherein the step of forming a series of multiple interlockable components includes configuring the first and second hulls and the deck member to be securely interlocked to another without use of tools in order to assemble the boat.

15. A portable boat of the type which, when assembled, includes first and second hulls spaced apart a predetermined distance, with the first hull connected to a starboard side of a deck member and the second hull connected to a port side of the deck member, wherein the deck extends from a fore member to an aft member, the boat comprising:
multiple interlockable components including the first and second hulls and the deck member, each configured to be securely interlocked to another to assemble the boat, which components, when assembled, result in connection of each hull along a different side of the deck member,
wherein the deck member includes:
at least one deck tenon extending outward from the starboard side of the deck member for connection with the first hull and at least one deck tenon extending outward from the port side of the deck member for connection with the second hull, and the assembled boat has a continuous surface area on the deck member between the first and second hulls over which a passenger can walk and be seated and
wherein each of the hulls includes at least one slotted opening for receiving one of the tenons to connect the hull to the deck member, so that when at least one deck tenon is inserted into one of the hulls, the hull is securely fastened to the deck member with the aid of a fastener extending from the hull into the deck tenon.

16. The boat of claim 15 wherein each of the first and second hulls comprises multiple separate but connectable hull sections and each hull provides a predetermined hull length when the boat is assembled by provision of each of the multiple separate hull sections with a length smaller than the predetermined hull section length, with the hull section lengths combining to provide the predetermined length when the hull sections are connected.

17. The boat of claim 16 wherein the deck member includes:
at least two deck tenons extending outward from the starboard side of the deck member for connection with the first hull and at least two deck tenons extending outward from the port side of the deck member for connection with the second hull, and
each of the first and second hulls includes two separate but connectable hull sections each including at least one slotted opening for receiving one of the deck tenons to connect each of the hulls to the deck.

18. The boat of claim 16 wherein for each hull, by connecting the sections of the hull and receiving one of the deck tenons into a slotted opening in each of the connectable hull sections, the hull sections become secured to one another and the hull becomes secured to the deck member.

19. The boat of claim 16 wherein the sections of each hull are secured to one another and the hull is secured to the deck member with fasteners that extend through the hull sections and deck tenons.

20. The boat of claim 18 wherein a first of the connectable hull sections includes a hull tenon for insertion into a second one of the connectable hull sections and the second of the connectable hull sections includes a recess for receiving the hull tenon.
